(19) United States
(12) Patent Application Publication
(10) Pub. No.: US 2010/0153983 A1
(43) Pub. Date: Jun. 17, 2010

(54) AUTOMATED PRESENCE FOR SET TOP BOXES

(76) Inventors: Earl Warren Philmon, Raleigh, NC (US); Collin Regault Rountree, Johns Creek, GA (US); Paul E. Rubenstein, Roswell, GA (US); Hannah W. Wang, Johns Creek, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/652,771

(22) Filed: Jan. 6, 2010

Related U.S. Application Data
(63) Continuation-in-part of application No. 12/334,797, filed on Dec. 15, 2008.

(51) Int. Cl. H04H 60/33; H04H 60/32

(52) U.S. Cl. 725/13; 725/14

(57) ABSTRACT

Exemplary automated presence detection systems comprise set top box components equipped with a Bluetooth receiver, or another receiver configured to receive data from a personal identification device via a wireless and automatic radio frequency standard. In various embodiments, the Bluetooth receiver may be integrated into the set top box or may operate as an adjunct to an existing set top box. The wireless radio frequency receiver in the set top box will poll to determine the presence of previously paired personal identification devices. If any such device is present, then the set top box will track and record the presence of a viewer that is associated with the device and correlate the viewer's presence with content displayed on the television or other local content display component. Alternatively, based on detected viewer presence, some embodiments of an automated presence detection system may be configured to push and/or restrict specific content. Further, some embodiments are configured to gather statistical data concerning viewer behavior and/or exposure to displayed content.

### CROSS REFERENCE TO RELATED APPLICATIONS

This application is a continuation-in-part of the United States patent application having Ser. No. 12/334,797, filed on Dec. 15, 2008 and entitled PRESENCE BASED COMMUNICATION CONTROL, the entirety of which is hereby incorporated by reference. This application is related to the United States patent application entitled AUTOMATED PRESENCE DETECTOR FOR MOTOR VEHICLES, filed concurrently herewith and having an attorney docket number of 07001.1525, the entirety of which is hereby incorporated by reference.

### BACKGROUND

Unlike cable and satellite media service providers, broadcast television operators don't have the benefit of a dedicated media conduit into a subscriber's home. In fact, because broadcast television operators simply transmit content over the airwaves for the benefit of anybody with a television set and a receiver, they don't even have subscribers—they only have users. Consequently, broadcast television operators don't generate any revenue from subscriber fees and, instead, rely heavily on revenues generated from network and advertising contracts to stay profitable.

Of course, advertisers on broadcast television want to know what they are getting for their money, i.e. they want to quantify the number of eyeballs that are focused on a given advertising spot. Because broadcast television operators don't have subscriber lists, narrowing down and subsequently quantifying advertisement exposure can be a moving target.

A well known company by the name of Nielson Media Research, which came into existence in the early 20^{th} century shortly after the advent of the television itself, provides a service to the broadcast television industry for statistically quantifying viewership. Simply described, Nielsen provides such a service by placing a “black box” meter (just a computer and a modem) in communication with the television sets of a representative sampling of households. The “black box” monitors channel selection, viewing time, etc. and transmits the collected data back to a Nielsen server. Nielsen, in turn, uses such statistical sampling data in combination with known program data in order to statistically calculate viewership. From this data, broadcast operators, networks and advertisers make somewhat informed decisions about programming popularity and advertising exposure.

In addition to the traditional broadcast media operators, Nielsen also provides its services to the cable and satellite operators. For years, when it comes to viewership quantification and behavioral data collection, however, cable media operators have had an additional advantage over broadcast television operators in that cable operators benefit from a dedicated broadband network connection that is wired directly into a subscriber's home. Satellite based media service providers also enjoy dedicated broadband connectivity to a subscriber's home, albeit generally asymmetrical in nature. Regardless, for cable and satellite media service providers, the dedicated broadband connectivity to subscribers is a crucial component in the business models of those industries, as the connectivity can be leveraged in light of Nielsen data in order to greatly improve an individual subscriber's experience. In effect, while broadcast television operators transmit content to the masses in a collective manner, cable and satellite media service providers can filter and transmit content in a targeted manner. Improving subscriber experience, in turn, potentially gains the service provider a competitive advantage in the media delivery and advertising markets.

From the perspective of a media provider or advertiser, accurate statistical calculations as to the number of viewers during a given time slot is valuable. Even more valuable, however, is data collected on the specific demographics and behavior of the statistical sample used by services like Nielsen, small though the sample is, to derive the viewership count. Even more valuable than data collected on the small statistical sample of homes targeted by a company like Nielsen, is data collected on larger samples taken directly from a content provider's subscriber list.

Beyond that which is provided by Nielsen, little knowledge about the viewing habits of particular users within a home has been available to the service provider, advertisers or program content creators. Service such as those provided by Nielson have served as the industry's only mechanism to capture statistics on customer behavior and preferences. This information is expensive and, because Nielsen's statistical sample is so small (approximately 5000 households out of an estimated 99 million with televisions, according to Nielson's website in September of 2009), the data is far from comprehensive. Further, the data collection systems and methodologies of Nielsen and others don't provide any real-time mechanism for tracking viewership demographics and behavior. It is reasonable that with more accurate and comprehensive information, a service provider could make significant improvements in service offerings to subscribers while simultaneously providing a more valuable and targeted offering to advertisers.

Existing systems and methodologies for collecting data on viewers of media programming are antiquated and subsequently limited in the value of data that can be collected. Data collection on programmed media and advertising viewership could be vastly improved by the introduction of technology that exploits a cable or satellite media provider's “set top box” processing capability and subscriber dedicated network connectivity.

### BRIEF SUMMARY

The disclosure presents various embodiments, as well as features and aspects thereof, of a data collection technique and system. Exemplary embodiments define a monitoring zone in which a user may be exposed to various media content. The presence and/or actions of a user in that zone is detected and/or monitored by some embodiments such that exposure to media content can be mapped to a user's demographics. Other embodiments, alternatively, push or restrict media content based on the presence of identified viewers. Still other embodiments track the reaction of an identified user to the exposure to specific content.

The presence of a specific person viewing a television can be automatically detected by using Bluetooth technology or another similar radio frequency standard. A specific viewer carrying a Bluetooth enabled device can be tracked via a receiver residing within a typical “set top box” that is in communication with a television, for example. The configured set top box can track the content that is displayed on the television and simultaneously, via the Bluetooth receiver, correlate the physical presence of specific viewers who are within viewing distance of the television.

Upon entering a room with a Bluetooth enabled set top box, or similar equipment, a specific viewer carrying a previously paired Bluetooth device may be logged by the set top box as “present” and, presumably, in view of the television. The presence of the viewer is detected and confirmed by the set top box as the previously paired Bluetooth device carried by the viewer is automatically “connected to” the receiver residing within the set top box. Once the viewer's device has been successfully detected and identified by the set top box component, demographic data of the particular viewer, or group of viewers, who is associated with the personal device can be mapped to the content that is displayed on the television while the viewer is present.

The “pairing” methodology, generally, is the means by which Bluetooth enabled devices set up security for communicating with one another and is well known in the art of radio frequency communication. Further, the term “connect” or any conjugate thereof, is used herein generally to describe the step in which a component of an automated presence detection system may recognize and/or verify the presence of another component within the system. For this reason, even though some embodiments of an automated presence detection system may establish a paired connection as is known in the specific art of Bluetooth technology, the interpretation of the present disclosure will not be limited to Bluetooth specific connections, even when the words “pair,” “connect,” or conjugates thereof are used in conjunction with the word “Bluetooth” in an exemplary description.

Even further, though the present disclosure will commonly refer to the Bluetooth technology, it is contemplated that other radio frequency standards, IR wavelength signals or any suitable communication/protocol technology or methodology may be comprised within various embodiments of an automated presence detection system and the employment of any given communication standard or protocol, or lack thereof, will not limit the scope of that which is disclosed. Accordingly, reference to the Bluetooth radio frequency is offered for illustrative purposes only and should not be read such that embodiments of an automated presence detection system are limited to comprising only Bluetooth technology or ranges. The use of Bluetooth in this disclosure, therefore, can be interchanged with any number of wireless communication technologies including, but not limited to, WiFi standards, 802.1x standards, or any communication protocol useful for transmitting data over a wireless connection. Moreover, though the Bluetooth technology is generally limited to a transmission range under 100 meters (commonly under 10 m), such a typical transmission range, which may define a monitoring zone for an exemplary embodiment of an automated presence detection system, is a function of system power and frequency and will not be read to imply a limit on the range of an automated presence detection system monitoring zone.

Existing technologies attempt to track similar viewer specific data by providing a remote control, for example, that is operable to communicate with the set top box via a number of different Infrared wavelengths, each wavelength being associated with a specific viewer. While such a solution certainly links a specific viewer with displayed content, it cannot simultaneously track other viewers that may be exposed to the same content. Such systems can only assume that the particular viewer associated with the wavelength being used by the remote control is present. Further, such systems have no means to positively determine that a particular viewer, or viewers, has entered or exited the media viewing zone. Advantageously, embodiments of an automated presence detection system, however, may track the presence of multiple viewers, potentially representing multiple demographics, who are simultaneously exposed to certain content. Further, it is an advantage of an automated presence detection system that viewer presence can be tracked in a passive manner, i.e. a viewer's presence is recognized simply by entering the Bluetooth zone, thus requiring no proactive action on the part of the viewer to inform the system of his presence.

Even further, because multiple viewers may be tracked and linked to displayed content, it is another advantage of embodiments of an automated presence detection system that displayed content may be linked not only to multiple viewers individually, but also to multiple viewers collectively. As a non-limiting example, content providers, programmers and advertisers may employ embodiments of an automated presence detection system to track viewing slots or programming content of which parents and teenage children tend to view together. Stated another way, embodiments may be able to apply algorithms in order to determine specific viewer combinations, thereby providing the option of mapping or pushing content accordingly.

Yet another advantage of embodiments of an automated presence detection system is that remote channel changing devices equipped with a GPS transmitter, or some other means for position identification, may be associated with the viewer to whom it is most proximately located, the viewer's on-person tracking device also having an embedded means for position identification, thereby determining and tracking which specific viewers are in control of channel selection, volume, recording device programming, etc. Some embodiments may utilize signal strength detection of a Bluetooth or otherwise equipped personal identification device to determine the relative positions of a viewer and remote channel changing device. For instance, a remote control device may include a Bluetooth receiver configured to recognize and transmit to the set top box the identity of a proximate viewer, based on its recognition of the location or proximity of a viewer's personal identification device. Alternatively, the personal identification device of a viewer may be able to determine its immediate proximity to the remote control device, thereby reporting to the set top box component that the associated viewer possesses the remote control.

To provide such functionality, exemplary embodiments of an automated presence detection system may comprise a set top box component with a GPS receiver that is configured to receive position coordinates from a viewer device and a television remote control device and subsequently associate one with the other. Other embodiments may comprise a viewer device component that is equipped with a GPS receiver and configured to receive GPS coordinates from the remote control device, subsequently transmitting to the set top box that the remote control is in the domain of the viewer associated with the viewer device. Alternatively, the same methodology could work in the reverse, wherein the remote control has the GPS receiver. Importantly, the description of such functionality in connection with GPS technology is provided to illustrate how some embodiments of an automated presence detection system may determine who of the present viewers is in direct control of a remote control device. The specific reference to GPS is used herein generally to describe position location functionality and is not meant to limit the means by which embodiments of an automated presence detection system may determine component locations.

As a non-limiting example, an embodiment of an automated presence detection system may recognize the presence of two user devices in a given zone, thereby determining that a father and his teenage daughter are viewing television content together. Because the remote control is active and in close proximity to the father, the system could be configured to track the father as the present viewer in control of program selection. Furthering the scenario, should the father pass the remote to the daughter for programming a TiVo or some other recordation device, the system could also track the programming selection to be recorded for later viewing and, accordingly, link the daughter, along with the demographics she represents, to the selected programming. Even further, should the daughter pass the remote control back to the father, the system could subsequently document that the father routinely reduces the volume during commercials or exhibits other notable viewing behavior. Notably, these examples are offered for illustrative purposes only and are not meant to be an exhaustive list of all the statistical data gathering scenarios in which an automated presence detection system may be useful. Various statistical data gathering algorithms that are employable by various embodiments of an automated presence detection system, although perhaps novel in and of themselves, will be known to those skilled the art.

It is contemplated that the user device will typically be a cellular based mobile device, an application running on a mobile device or some other device that is uniquely associated with a specific user. Even so, a Bluetooth capable device that is not a telephone, PDA, pager or the like could also be substituted. Additionally, a device specifically designed to pair with a set top box receiver could also be used. Notably, the term “set top box” is used herein generally and is meant to reference a system component that, for example, may be configured in any combination with functionalities such as, but not limited to: tracking displayed content, recognizing present viewers via a Bluetooth receiver (or the like), mapping present viewers, mapping the behavior of present viewers, pushing specific content based on viewer presence, transmitting statistical data to a receiving entity, analyzing statistical data, etc. In some embodiments, the functionality of the set top box component may be incorporated into a standard channel changer in a satellite or cable system. Alternatively, some of the functionality could be in a standalone system that connects to components with the channel changer or some or all of the functionality may be incorporated into a television set or monitor. The specific combination of functionality associated with a set top box or similar component in an automated presence detection system may vary from one embodiment to another and may be novel in and of itself. Regardless, various embodiments of an automated presence detection system may comprise set top box components with varying levels of functionality and, therefore, the specific functionality of a set top box component or, for that matter, any component within the system, will not limit the scope of that which is disclosed herein.

Advantageously, a Bluetooth enabled device that is uniquely associated with a specific user provides a means for an automated presence detection system to track and log television programming and advertisement exposure on a specific demographic level. More specifically, by identifying the presence of a specific user, and the demographics associated with that user (gender, age, etc.), a set top box equipped with a Bluetooth receiver, for example, may be operable to map very specific and relevant data concerning viewing behavior and preferences that can be generally attributable to a larger, similarly situated demographic within a given subscriber base. As a non-limiting example, content providers may be interested in tracking the viewing behavior, such as program selection or viewing session duration, of system users ranging in age from 13 to 16 who are not in the presence of a parent. From such data, content providers may be able to target programming or advertisement content that is attractive to a 13 to 16 year old demographic but in similar studies has been shown to be of no interest to adults.

More specifically, addressing exemplary set top box components in embodiments of an automated presence detection system, a Bluetooth receiver, or another receiver configured to receive data via a wireless and automatic radio frequency standard, can be integrated into the set top box or can operate as an adjunct to an existing set top box. As is known in the art, the receiver in the set top box will poll to determine the presence of previously paired Bluetooth devices. If any such device is present, then the set top box will track and record the presence of the associated viewer and correlate the viewer's presence with content displayed on the television or other local content display component. Alternatively, based on detected viewer presence, some embodiments of an automated presence detection system may be configured to push specific content. It is contemplated that embodiments of the system will require a simple set up process in order to register each potential viewer to be tracked and to associate the appropriate Bluetooth device with that viewer.

Many existing set top boxes have an integrated central processing unit and operating system. Those set top boxes are also capable of communicating externally via Internet Protocol connections through a service provider's network. This connection capability enables for centralized record keeping and information management. When a user's Bluetooth device is physically local to a set top box, the Bluetooth device in the set top box will detect such presence and forward associated information, such as viewer demographic data, to the CPU and to the network. This information will be used to take actions related to recording what a user is watching, and can be used to engage with the viewers with advertisements, polling actions, interviews and other actions.

### BRIEF DESCRIPTION OF THE SEVERAL VIEWS OF THE DRAWING

FIG. 1 illustrates an exemplary environment in which embodiments of an automated presence detection system may be employed.

FIG. 2 depicts an exemplary methodology used by some embodiments of an automated presence detection system, wherein displayed content is mapped to a present viewer.

FIG. 3 depicts an exemplary methodology used by some embodiments of an automated presence detection system, wherein mapped data is streamed to a provider's central server.

FIG. 4 depicts an exemplary methodology used by some embodiments of an automated presence detection system, wherein actuation of a television remote control, in addition to displayed content, is mapped to a present viewer.

FIG. 5 depicts an exemplary methodology used by some embodiments of an automated presence detection system, wherein displayed content is pushed to a present viewer.

FIG. 6 depicts an exemplary methodology used by some embodiments of an automated presence detection system, wherein content is displayed on an authorization basis.

FIG. 7 is a functional block diagram of components comprised within an exemplary embodiment of an automated presence detection system.

### DETAILED DESCRIPTION

The presently disclosed embodiments, as well as features and aspects thereof, are directed towards providing a system that can recognize the physical presence of a content viewer and correlate that viewer's presence with presumed exposure to specific content that is displayed. Further, some embodiments may link specific demographics associated with a present viewer, or viewers, to content displayed in the viewer's presence. Still other embodiments may track a present viewer's behavior in response to displayed content, such as channel changing, volume control, etc. Even further, some embodiments may be operable to transmit the collected data, such as viewer data correlated with displayed content data, to a central server or some other system component.

Again, a benefit of some embodiments of an automated presence detection system is the provision of data collection wherein the exposure of specific viewers to displayed content (such as but not limited to, advertisements or programming on a television) may be tracked. In this way, a Nielsen-like service owned and managed by a network operator, for example, could be deployed in order to capture useful marketing data. As has been described, virtually endless algorithms are contemplated for collecting data associated with recognized content viewers. Such data collection may be useful for network operators, content programmers, advertisers or any entity interested in collecting and analyzing viewer statistics.

It is contemplated, however, that other embodiments of an automated presence detection system may be useful for control and access management of delivered content. For example, parental control features may be incorporated in some embodiments such that access to certain services may be limited to certain viewers, viewing sessions may be time limited, various metrics may be customized to all viewers, etc.

Some embodiments may be configured to actively push content in real-time, such as targeted advertising for example, based on the recognized presence of a given viewer. Still other embodiments may feature a polling means such that present viewers, authenticated based on the system's recognition of a personal Bluetooth device, may be engaged in surveys, thus providing an easy, efficient, and convenient mechanism for the capture of statistical opinion data.

Turning now to the figures, where like labels represent like elements throughout the drawings, various aspects, features and embodiments of an automated presence detection system will be presented in more detail. The examples as set forth in the drawings and detailed description are provided by way of explanation and are not meant as limitations on the scope of an automated presence detection system. An automated presence detection system thus includes any modifications and variations of the following examples as come within the scope of the appended claims and their equivalents.

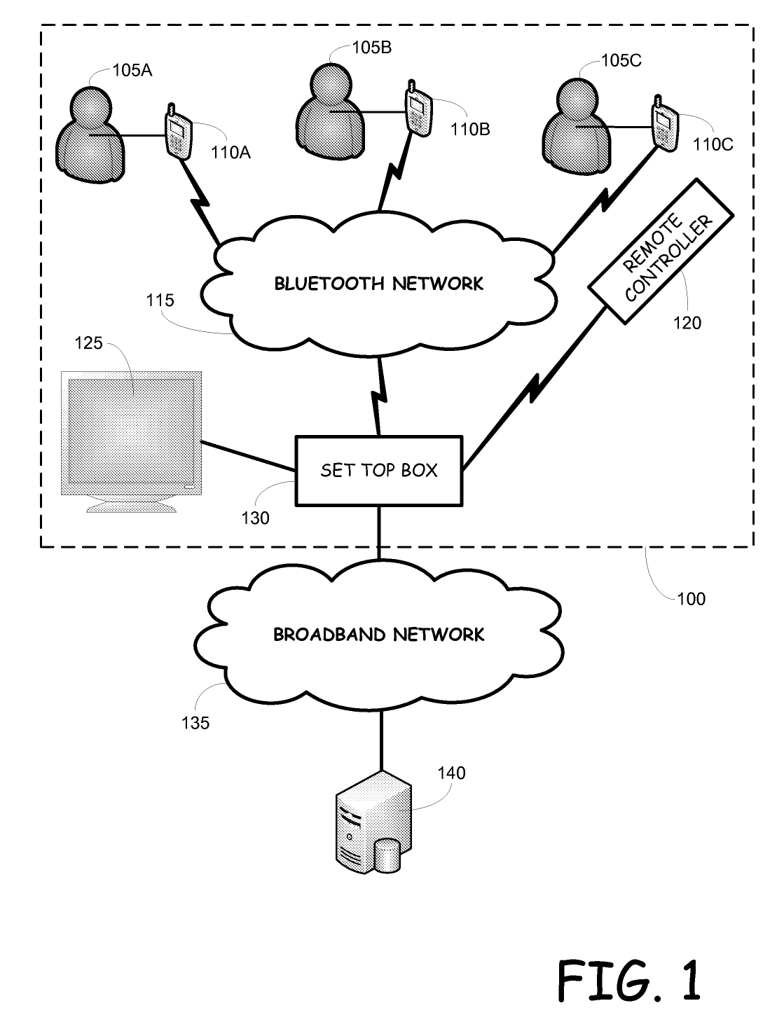

FIG. 1 illustrates an exemplary environment in which embodiments of an automated presence detection system may be employed. Within the Bluetooth zone 100, generally, is a set top box 130, a content display component 125, possibly a content display component remote controller 120 and any number of content viewers 105 that are individually associated with a Bluetooth enabled personal device 110. Notably, the FIG. 1 illustration is offered for exemplary purposes only and, as such, depicts three viewers 105A-C associated with three personal devices 105A-C. It is contemplated that the presence and viewing behavior of more, or less, than three viewers may be tracked by various embodiments of an automated presence detection system.

Further, for the purpose of this description, each viewer 105 is assumed to be associated with a Bluetooth enabled personal device 110 that is both unique to the viewer as well as residing on the person of the viewer. The unique personal device associated with a viewer operates to provide embodiments of the system with a means to positively identify the presence of a specific user as well as any demographics that may be previously associated with the specific user. For this reason, when the term “viewer” is used in this description, it should be assumed by the reader that a personal device associated with the viewer is inherently being referenced as well, unless otherwise stated. Also, as has been previously articulated, it should be understood that the term “Bluetooth” is used in the present description in a general manner to reference any wireless communication means or protocol that may be used to recognize the physical presence of a device in a geographical zone and, therefore, embodiments of an automated presence detection system may not employ the specific wireless radio frequency standard known in the art as Bluetooth.

As viewers 105 enter or exit the Bluetooth zone 100, a set top box component 130 may automatically connect itself over a local Bluetooth network 115, via either an embedded or external Bluetooth receiver, with the given viewer's Bluetooth enabled personal device 110. In this way, the set top box 130 may track the presence of specific viewers 105 that are being exposed to content displayed on the content display component 125. By recognizing the presence, or absence, of specific viewers 105, embodiments of an automated presence detection system may map viewer demographics to displayed content, collect behavioral data in response to displayed content, filter the delivery of displayed content, administer interactive data collection surveys, push specific content, etc.

For example, an embodiment of an automated presence detection system may be configured to, among other things, map viewer demographics to displayed content. Such an embodiment may include a set top box 130 component that is configured to receive content from a content provider (such as a network operator). The content provider, whether a cable provider, satellite provider or otherwise, may deliver its content to a customer set top box 130 over the requisite broadband network 135, as is commonly known in the art. Similar to other systems already known in the art, the exemplary embodiment of an automated presence detection system may display the provider's content on a local content display component 125, such as a television or monitor.

Unlike other systems already known in the art, however, the set top box component 130 of the exemplary automated presence detection system may be communicable with a Bluetooth receiver and configured to recognize, via a Bluetooth network 115, the presence of a specific viewer 105. In doing so, the set top box 130 component may track the presence of a given viewer 105 and statistically map that viewer's presence to content being displayed on the local monitor 125 (or monitors, for that matter). The statistical data that is collected by the exemplary embodiment may be streamed in real time to a content provider 140 via the broadband connection 130 or, alternatively, stored locally and transmitted at a later time. Further, it will be appreciated that some embodiments of an automated presence detection system that use Bluetooth may comprise a set top box component that is operable to provide and receive audio feedback to/from a viewer. For instance, the set top box may specifically send audio signals to the viewer requesting various types of feedback, verbal or otherwise, from the viewer. The set top box in such embodiments may also include a VXML system to allow viewers to enter DTMF responses to audio prompts and menus.

Such data collection and statistical mapping may be useful to content providers to improve content delivery, quantify advertisement value, assess program matrixes, etc. Some embodiments may comprise a set top box 130 component that is configured to compile the collected data and perform statistical analysis prior to transmitting the results to a content provider's server 140. Other embodiments may simply identify the presence of a viewer 105 and transmit the identity of the viewer 105 to the content provider 140 along with any associated data collected while the viewer 105 was present, thereby leaving the statistical analysis to the content provider 140.

Other embodiments of an automated presence detection system may be configured to collect and map behavioral data to specific viewers. For example, a set top box 130 component, in addition to comprising a Bluetooth receiver, may also comprise a means for location detection (such as a GPS receiver) within the Bluetooth zone 100. In such an embodiment, the Bluetooth enabled personal devices 110 of various users 105 may further comprise GPS transmitters or the capability of transmitting a current location data. Also, a remote control device 120 for a content display monitor 125 may comprise a GPS transmitter. As is known in the art, the remote control device 120 may be configured to manipulate the content displayed on a television 125 via Infrared communication, or some other communication means, with the set top box 130 (channel changing, volume control, etc.).

The set top box 130 of the exemplary embodiment may be operable to correlate the physical location of a remote control device 120 with the physical location of a specific viewer, such as viewer 105C, who is physically present within the Bluetooth zone 100. Advantageously, by correlating a remote control device 120 with a specific viewer, behavioral data may be collected and associated with the specific viewer. Such data collection may be useful to content providers in that it goes further than just mapping displayed content to a viewer's presence by actually mapping a viewer's reaction to displayed content. For example, it may be useful to know that a viewer always reduces the volume when exposed to a certain commercial or changes the channel when certain content is displayed.

As has been described, data collection algorithms and statistical calculations employed by embodiments of an automated presence detection system will be known to those skilled in the art. For this reason, the specific data collection algorithms or statistical calculations described herein to be used by various embodiments are offered for exemplary purposes only and will not limit the scope of the present disclosure. Some embodiments, for example, may be configured to recognize certain combinations of present viewers and subsequently map displayed content and/or behavior to the specific viewer combination.

As a non-limiting example, suppose viewer 105C was a father to teenage viewers 105A and 105B. The set top box 130, via the Bluetooth network 115, may be able to identify the presence of the viewers 105A-C along with the demographics associated with each. Subsequently, the system embodiment may be able to map the content displayed in the presence of all three viewers 105A-C and, further, may also be able to map the behavior of the father 105C via the actuation of the proximate remote control 120. Advantageously, should the father 105C leave the Bluetooth zone 100 and/or relinquish the remote control 120 to teenage viewer 110B, the embodiment may be able to track the subsequent content selection and map it to the presence of the teenage viewers 105A-B sans the father's 105C presence.

Again, some embodiments of an automated presence detection system may be operable to filter displayed content and/or push specific content. As a non-limiting example, suppose viewer 105C, the father in the previous example, is the only viewer present within the Bluetooth zone 100. As previously described, the set top box 130 may recognize his presence and present the advertising content such that the subject matter of the advertisements he is exposed to is tailored to his interests or needs. Alternatively, suppose the teenage viewers 105A and 105B are the only viewers present within the Bluetooth zone, the content may be filtered through the set top box 130 prior to being displayed on the content display component 125 such that only programming deemed appropriate for the viewer 105A-B demographic may be displayed.

The previous examples are offered for illustrative purposes only. It should be understood that statistical analysis, content filtering/pushing, and other functionalities described herein relative to certain components within embodiments of an automated presence detection system may be performed by other components within a given embodiment. Alternatively, some of the functionality described herein may be performed by the system operator 140 and transmitted to various embodiments of an automated presence detection system via a broadband network 135.

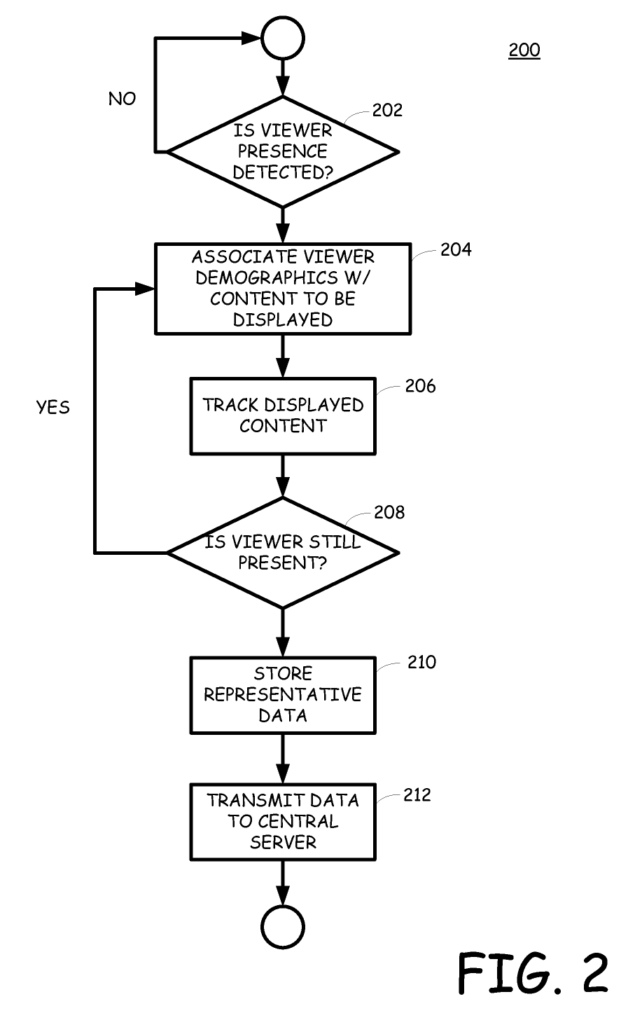

FIG. 2 depicts an exemplary methodology 200 used by some embodiments of an automated presence detection system, wherein displayed content is mapped to a present viewer. As has been described, a set top box component within an automated presence detection system may be configured to poll a Bluetooth zone, detect 202 a viewer who has entered the zone and connects itself with a Bluetooth enabled personal device (or simply recognize its presence) that is uniquely associated with the viewer. In this way, an automated presence detection system may track the presence of specific viewers wherein it is presumed that a present viewer is exposed to displayed content.

If an automated presence detection system does not detect 202 the presence of a viewer within the zone, it may continue to poll the zone in anticipation of a viewer being detected 202. Once a viewer is detected 202, embodiments of an automated presence detection system may associate 204 previously stored demographics of the user with content that will be displayed while the user remains in the zone. Accordingly, displayed content is tracked 206 while the viewer is present and continuously associated 204, or mapped, with the viewer demographics. While continuously mapping 204 and tracking 206, the system is also polling 208 the zone to confirm that the identified user is still present. Assuming that the identified user is still present, the system will continue to track 206 the displayed content and map 204 it to demographics of the user. In this way, statistical data on a viewer's exposure to content is collected.

An embodiment of an automated presence detection system that employs the exemplary methodology 200 will continue to poll 208 the zone in an effort to verify a viewer's continued presence, or absence thereof. If a present viewer is determined to have exited the polled zone, the system may store 210 the collected data that is representative of the tracked viewing session and transmit 212 the data to the system of the administrating entity (such as a network operator). Because representative data is stored 210 locally on the set top box component prior to being transmitted 212 to the administering entity, an advantage of an embodiment having such functionality would be the provision of a means for transmission of collected data at predetermined times, as well as allowing local review of viewed content data.

Importantly, the exemplary algorithm of the present methodology is offered for illustrative purposes only and, therefore, it is contemplated that some embodiments of an automated presence detection system may be configured to administer variations. Some embodiments, for example, may employ an algorithm with a varying order of steps and, further, some embodiments may be configured such that different components from those previously described perform certain steps.

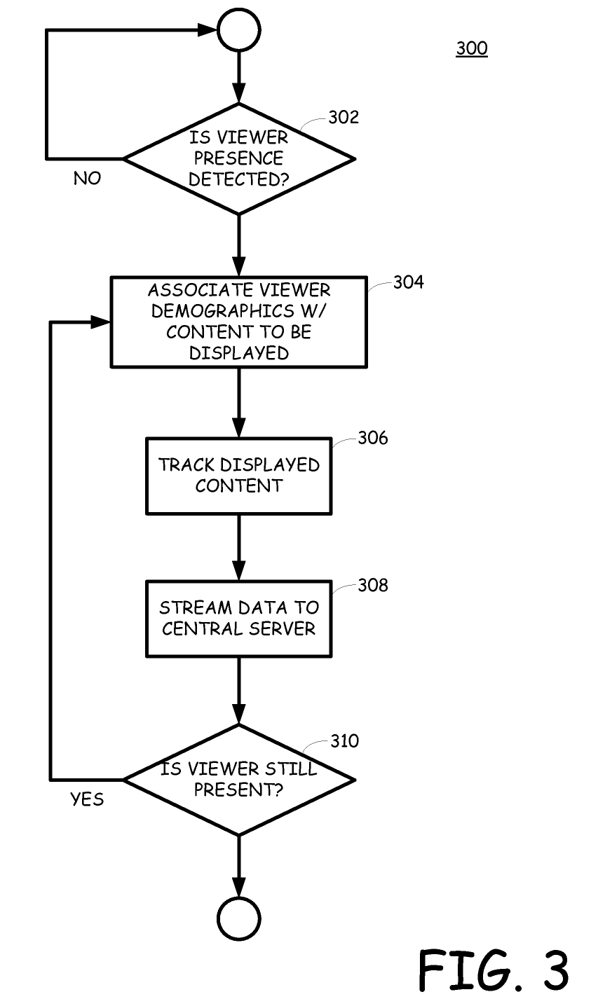

FIG. 3 depicts an exemplary methodology 300 used by some embodiments of an automated presence detection system, wherein mapped data is streamed to a provider's central server. An exemplary embodiment configured to perform methodology 300 may not store 210 representative data on the set top box component (beyond temporary storage in RAM), preferring in the alternative to establish a streaming connection to the administering entity. An advantage of establishing a streaming connection to a receiving entity is that collected data may be continuously transmitted in real time.

Similar to an embodiment that employs exemplary methodology 200, an automated presence detection system configured to employ exemplary methodology 300 will poll 302 a Bluetooth zone in an effort to determine the presence of a viewer. If a viewer enters the zone, the system will recognize the Bluetooth enabled personal device of the viewer and subsequently associate 304 any viewer specific data with content that will be displayed while the viewer remains in the zone. As long as the viewer remains in the media viewing zone, displayed content will be tracked 306 and mapped 304 to the viewer. The statistical data that is the result of mapping 304 the viewer data to the tracked 306 content may be streamed 308 in real time to a receiving entity until the system determines 310 that the viewer has exited the media viewing zone. It will be appreciated that the term “stream,” and conjugates thereof, broadly represent a variety of teachings such as, but not limited to, opening a TCP channel for pushing content, texting, short message service transmissions, email transmissions and other communications means.

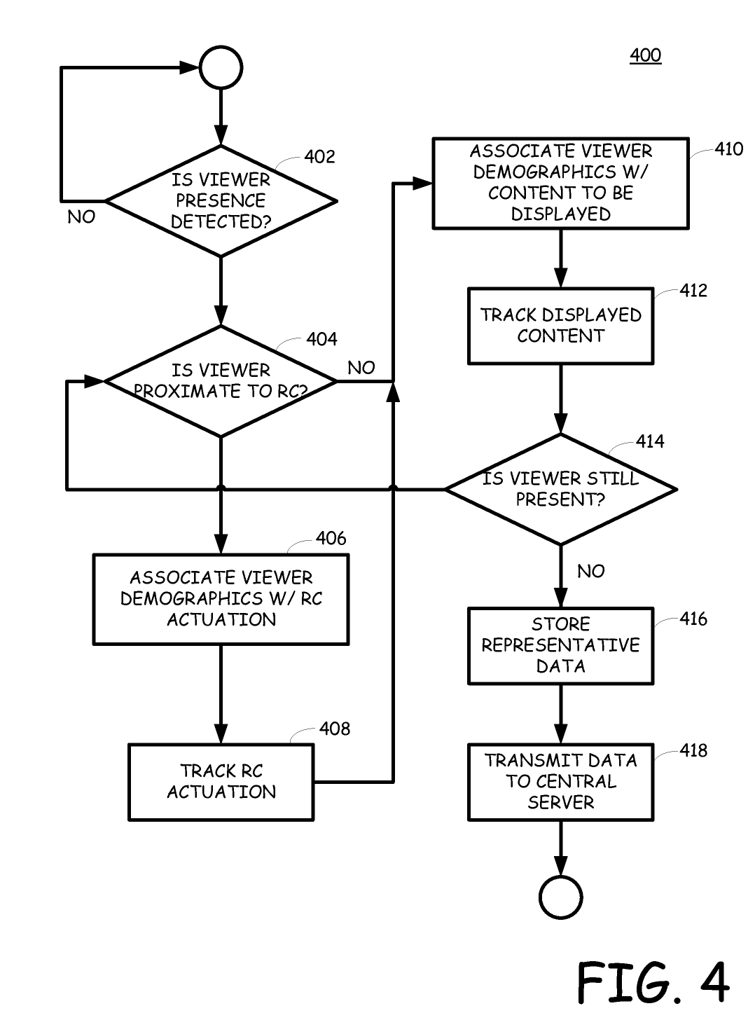

FIG. 4 depicts an exemplary methodology 400 used by some embodiments of an automated presence detection system, wherein actuation of a television remote control, in addition to displayed content, is mapped to a present viewer. An advantage of some embodiments of an automated presence detection system is to track displayed content and associate that content with a viewer that has been determined to be present within a media viewing zone. Such embodiments provide a means for effectively quantifying viewer exposure to specific content. It is contemplated that other embodiments, however, may go beyond mere correlation of viewer presence with displayed content by also tracking viewer behavior or reactions to the displayed content.

For example, an embodiment configured to employ methodology 400 will, like previously described embodiments, poll 402 the media viewing zone in an effort to determine the presence of a viewer (or viewers). If a viewer enters the media viewing zone, the system may monitor the physical location within the zone of a remote control device and determine 404 whether a viewer has established domain over the remote control device. Such determination 404 may be made, for example, by comparing GPS coordinates of the remote control device with GPS coordinates of a viewer's personal device, or conducting signal analysis or other techniques, as described later with regards to user prompts and feedback.

Once a viewer within the zone has been determined to have control of the remote control device, the system may associate 406 that viewer with subsequently tracked 408 actuations of the remote control. In this way, data may be collected that is representative of viewer behavior in response to displayed content such as, but not limited to, channel changing, volume control, etc. Of course, the system may also associate 410 the viewer with tracked 412 content, in much the same way as other embodiments.

The system will continue to poll 414 the zone in order to establish a viewer's continued presence as well as determine 404 which viewer within the zone is in control of the remote control device. Once a viewer exits the media viewing zone, data that is representative of the viewer's viewing session may be stored 416 locally and transmitted 418 to a receiving entity. Again, embodiments may not store data locally and instead establish a real-time streaming connection to the receiving entity. Further, some embodiments may actually perform statistical analysis at the set top box component (or some other component) whereas other embodiments may simply collect raw data and transmit that data to the receiving entity for statistical analysis.

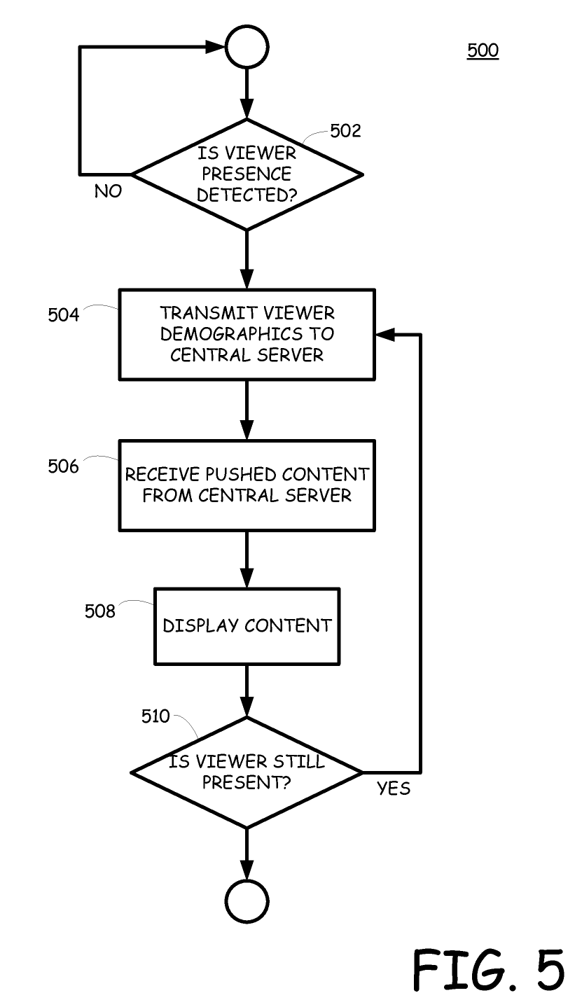

FIG. 5 depicts an exemplary methodology 500 used by some embodiments of an automated presence detection system, wherein displayed content is pushed to a present viewer. As has been described, the system will poll 502 a media viewing zone in order to determine the physical presence of a viewer. Once a viewer is determined to be present, embodiments of an automated presence detection system may transmit 504 to a content provider the demographics associated with that viewer (or combination of present viewers). Based on the received data that represents the demographics of a present viewer, or viewers, the content provider may push content back to the embodiment that is to be displayed 508 for the benefit of the identified viewer. In this way, targeted content may be delivered based on the presence of a viewer.

An embodiment configured to employ a methodology that pushes content, such as exemplary methodology 500, will continue to poll 510 the media viewing zone in order to identify the demographics associated with the present viewers. As the viewer demographics change, the embodiment may modify the displayed content 508 accordingly.

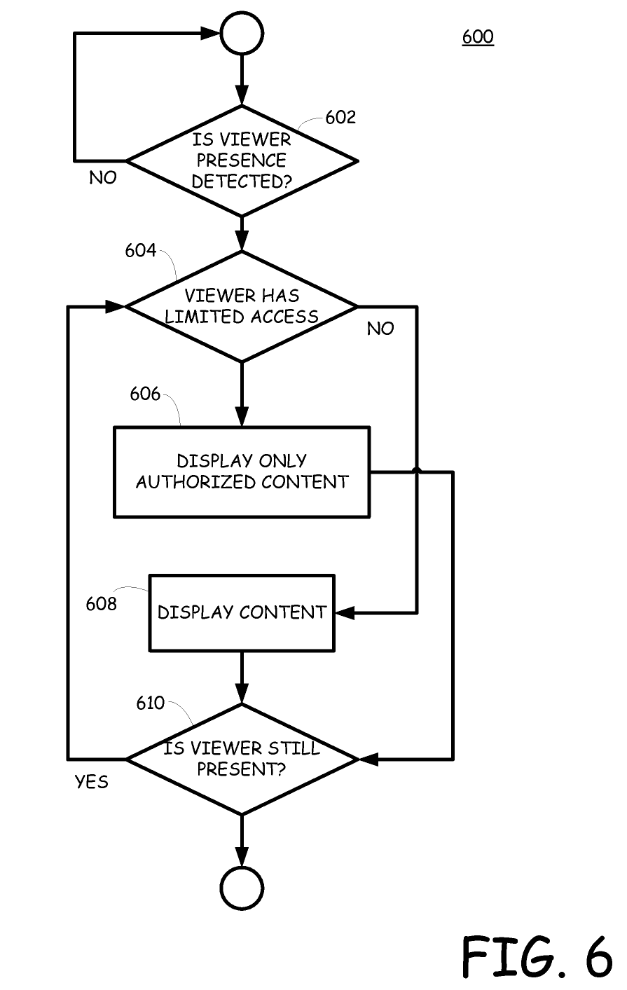

FIG. 6 depicts an exemplary methodology 600 used by some embodiments of an automated presence detection system, wherein content is displayed on an authorization basis. While the exemplary methodology of FIG. 5 has been described such that the content provider pushes specific content based on the identification of viewers by the automated presence detection system, other embodiments employing methodologies such as that depicted in FIG. 6 may be operable to effectively push specific content by simply filtering, based on the identification of present viewers, a “master” feed of pushed content.

Again, the system will poll 602 a media viewing zone in order to establish the physical presence of a given viewer. Once a viewer's presence has been established, the system may determine 604 whether the viewer (or combination of viewers) has limited exposure to displayed content. If the viewer has limited access, then the system may filter the “master” content feed such that only authorized content is displayed 606. Alternatively, some embodiments may not filter a “master” content feed but, rather, build an authorized content by adding various authorized feeds of content. Conceivably, whether the feed is constructed in an additive manner or filtered in a Boolean manner, the determination of an authorized feed may take place at the set top box component of an exemplary embodiment or, alternatively, may take place at the system of the content provider. Regardless, only authorized content may be displayed 606 and various methodologies and algorithms for determining the scope of such content will occur to those with knowledge in the art.

If a viewer's exposure is not limited to authorized content, the system may display 608 content without filtering. Of course, the system will continue to poll 610 the media viewing zone in order to determine the identity, or demographics of, present viewers such that only authorized content may be displayed 606, 608.

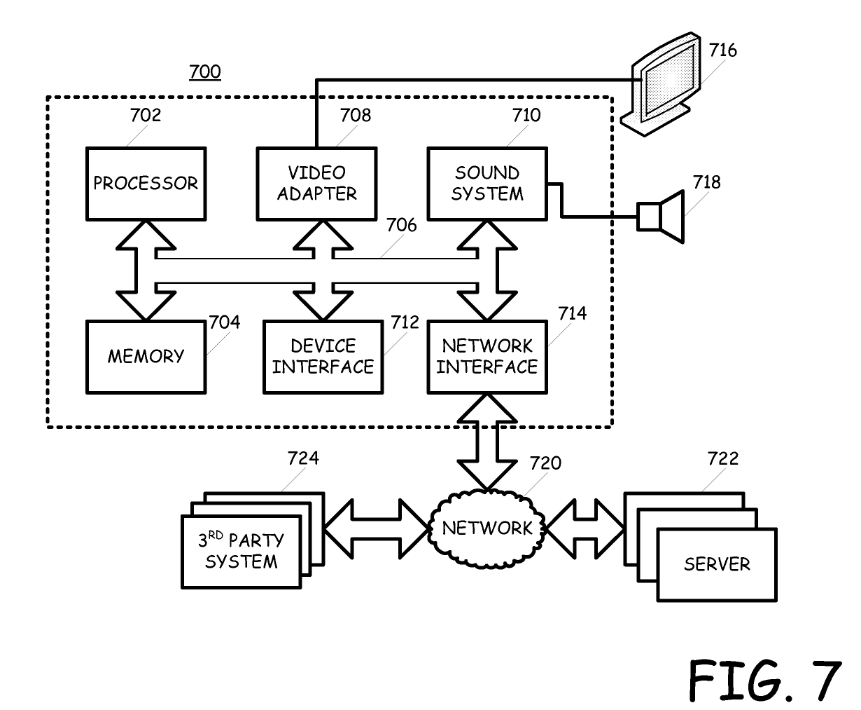

FIG. 7 is a functional block diagram of the components of an exemplary embodiment of an automated presence detection system. It will be appreciated that not all of the components illustrated in FIG. 7 are required in all embodiments of the automated presence detection system but, each of the components are presented and described in conjunction with FIG. 7 to provide a complete and overall understanding of the components, excluding the personal identification device, remote control, etc.

The exemplary set top box component 700 can include a general computing platform illustrated as including a processor/memory device 702, 704 that may be integrated with each other or, communicatively connected over a bus or similar interface 706. The processor 702 can be a variety of processor types including microprocessors, micro-controllers, programmable arrays, custom IC's etc. and may also include single or multiple processors with or without accelerators or the like. The memory element of 704 may include a variety of structures, including but not limited to RAM, ROM, magnetic media, optical media, bubble memory, FLASH memory, EPROM, EEPROM, etc.

The processor 702, or other components, may also provide functions such as a real-time clock, analog to digital converters, digital to analog converters, etc. The processor 702 may also interface to a variety of elements including, but not limited to, a device interface 712, a display adapter 708, audio adapter 710, and network/device interface 714. The device interface 712 provides an interface to external controls, such as sensors, actuators or the like.

The display adapter 708 can be used to drive a variety of content display elements 716, such as display devices including an LED display, LCD display, one or more LEDs or other display devices. The audio adapter 710 interfaces to and drives another content display element 718, such as a speaker or speaker system, buzzer, bell, etc. The network/device interface 714 may interface to a variety of devices (not shown) such as a keyboard, a mouse, a pin pad, and audio activate device, a PS3 or other game controller, as well as a variety of the many other available input and output devices or, another computer or processing device 722, 724.

Further, the network/device interface 714 can also be used to interface the computing platform to other devices, such as a receiving entity or content provider, through a network 720. The network may be a local network, a wide area network, wireless network, a global network such as the Internet, or any of a variety of other configurations including hybrids, etc. The network/device interface 714 may be a wired interface or a wireless interface. The computing platform is shown as interfacing to a server 722 and a third party system 724 through the network 720.

Another aspect that may be incorporated into various embodiments includes the ability to provide user feedback or verification. For instance, the personal devices may be able to receive signals or data from the set top box and/or provide signals or data to the set top box. Advantageously, this aspect enables the presence of a viewer to be further verified. As an example, if a user leaves his or her personal device within the monitored zone, but actually physically exits the zone, the set top box may erroneously assume that the viewer remains present. The present aspect of the system could allow the set top box to send a query or prompt to the personal device and request verification of the viewer's presence (ex: requesting the viewer to actuate a button on the device). Similarly, the set top box may require a watchdog timer or “handshake” to verify the viewer's presence. For instance, the personal device may periodically prompt the viewer to actuate the device to verify that not only is the personal device present, but that its associated user is engaged in viewing or experiencing the content.

In addition, the personal device, either on its own or in response to prompts from the set top box, may prompt the user to rate the content in a variety of manners. For instance, as a non-limiting example, the user may be requested to actuate the personal device to send one signal for content that is approved and another signal for content that is disapproved. Similarly, the content may be rated on a scale, such as “1 to 5” for the user's like or dislike of the content. As has been disclosed, some embodiments of an automated presence detection system that use Bluetooth may comprise a set top box component that is operable to provide and receive audio feedback to/from a viewer. For instance, the set top box may specifically send audio signals to the viewer requesting various types of feedback, verbal or otherwise, from the viewer. The set top box in such embodiments may also include a VXML system to allow viewers to enter DTMF responses to audio prompts and menus.

An automated presence detection system has been described using detailed descriptions of embodiments thereof that are provided by way of example and are not intended to limit the scope of the system. The described embodiments comprise different features, not all of which are required in all embodiments of an automated presence detection system. Some embodiments of an automated presence detection system utilize only some of the features or possible combinations of the features. Variations of embodiments of an automated presence detection system that are described and embodiments of an automated presence detection system comprising different combinations of features noted in the described embodiments will occur to persons of the art.

It will be appreciated by persons skilled in the art that an automated presence detection system is not limited by what has been particularly shown and described herein above. Rather, the scope of an automated presence detection system is defined by the claims that follow.

What is claimed is:

1. A system for identifying the physical presence of a personal device associated with a particular viewer within a monitoring zone, the system comprising:
at least one personal identification device comprising a wireless radio frequency transmitter, wherein the personal identification device is associated with a specific viewer and the effective range of the transmitter defines a media monitoring zone;
a content delivery component, wherein the component resides within said media monitoring zone;
a set top box component comprising a wireless radio frequency receiver, wherein the set top box component is communicatively coupled to said content delivery component and is operable to:
receive signal frequencies transmitted from the at least one personal identification device;
identify the viewer associated with the personal identification device, based at least in part on data transmitted via the received signal frequencies from the personal identification device; and
monitor media content displayed on a content display component.

2. The system of claim 1, wherein the set top box component is further operable to:
monitor, via said received signal frequencies, the continued presence of a viewer in the media viewing zone;
track the displayed media content;
map the tracked media content data to an identified viewer's personal data;
transmit the mapped data to a receiving entity.

3. The system of claim 2, wherein the mapped data is stored on the set top box component prior to transmission.

4. The system of claim 2, wherein set top box component is further operable to apply statistical analysis to the mapped data.

5. The system of claim 2, wherein the identified viewer's personal data comprises demographic data associated with the viewer.

6. The system of claim 2, wherein the set top box component is further operable to establish a streaming connection with the receiving entity such that the mapped data may be transmitted in real-time.

7. The system of claim 1, wherein the wireless radio frequency receiver and transmitter comply with the Bluetooth standard.

8. The system of claim 1, further comprising a remote control device operable to manipulate the content display component and wherein:
the remote control device comprises a means for transmission of position indication;
the at least one personal identification device further comprises a means for transmission of position indication;
the set top box component is further operable to:
receive position indication data associated with the remote control device and a personal identification device;
based on the received position indication data, associate the remote control device with a viewer associated with a personal identification device;
track the actuation of the remote control device;
map the tracked remote control device actuation data to an identified viewer's personal data; and
transmit the mapped data to a receiving entity.

9. The system of claim 8, wherein the received media content is an interactive survey and the actuation of the remote control device is representative of a viewer's answers to the survey.

10. The system of claim 1, wherein the received media content is an interactive survey, the personal identification device is further operable to receive actuations and transmit data representative of said actuations, and the set top box component is further operable to:
monitor, via said received signal frequencies, the continued presence of a viewer in the media viewing zone;
receive said data representative of the personal identification device actuations;
track the received representative actuation data;
map the actuation data to an identified viewer's personal data;
transmit the mapped data to a receiving entity.

11. The system of claim 1, wherein the set top box component is further operable to:
determine, for an identified viewer, an authorized level of access to the monitored media content;
monitor, via said received signal frequencies, the continued presence of an identified viewer in the media monitoring zone;
filter the received media content according to the determined level of authorization; and
display the selected media content on the content display component, instead of displaying the received media content.

12. The system of claim 1, wherein the subject matter of the monitored media content is based on the identification of a viewer.

13. The system of claim 12, wherein the monitored media content is an advertisement.

14. The system of claim 12, wherein identification of a viewer determines an authorized rating for the monitored media content.

15. The system of claim 1, wherein the at least one personal identification device is a cellular telephone.

16. A method for gathering statistical data via a set top box that comprises a wireless radio frequency receiver, a means for monitoring media content and a means for displaying media content, the method comprising the steps of:
polling a media monitoring zone;
detecting the presence of a personal identification device within the media monitoring zone that identifies an associated viewer;
associating demographics of the identified viewer with media content to be displayed;
tracking displayed media content while personal identification device remains within media monitoring zone; and
mapping identified viewer demographics data to tracked displayed content data.

17. The method of claim 16, further comprising the steps of:
storing the mapped data; and
transmitting the mapped data to a receiving entity.

18. The method of claim 17, further comprising the step of performing statistical analysis on the mapped data.

19. The method of claim 16, further comprising the steps of:
establishing a streaming connection to a receiving entity; and
transmitting the mapped data in real-time to the receiving entity.

20. A method for pushing media content via a set top box that comprises a wireless radio frequency receiver, a means for monitoring media content and a means for displaying media content, the method comprising the steps of:
polling a media monitoring zone;
detecting the presence of a personal identification device within the media monitoring zone that identifies an associated viewer; and
based on the demographics of the identified viewer, pushing specific content to a content display component.
